(19) United States
(12) Patent Application Publication
(10) Pub. No.: US 2008/0068392 A1
(43) Pub. Date: Mar. 20, 2008

(54) Display control apparatus, display control method, and program

(75) Inventors: Tsutomu Ichinose, Tochigi (JP); Yoshiro Miyoshi, Kanagawa (JP); Mitsuhisa Kaneko, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/900,550

(22) Filed: Sep. 11, 2007

(30) Foreign Application Priority Data
Sep. 15, 2006 (JP) JP2006-251136

(51) Int. Cl. G06T 9/00

(52) U.S. Cl. 345/555

(57) ABSTRACT

A display control apparatus includes: an input means for inputting an image of a compression target; a comparing means for comparing an input image inputted from the input means with a decompressed image that is obtained by decompressing a compressed image obtained by compressing the input image; an image processing means for changing a pixel value of a predetermined pixel of the decompressed image to a predetermined value based on a compared result by the comparing means; and a display means for displaying the decompressed image in which a pixel value is changed by the image processing means.

### CROSS REFERENCES TO RELATED APPLICATIONS

The present invention contains subject matter related to Japanese Patent Application JP 2006-251136 filed in the Japanese Patent Office on Sep. 15, 2006, the entire contents of which being incorporated herein by reference.

### BACKGROUND OF THE INVENTION

1. Field of the Invention

The present invention relates to a display control apparatus, a display control method, and a program, which can display an image corresponding to a compressed image so as to emphasize the image quality of the compressed image of the input image.

2. Description of the Related Art

In order to produce a packaged medium such as an optical disk, there is a data compressor which compresses data of materials such as video data and audio data to be recorded on a recording medium (for example, Patent Reference 1 (see JP-A-H10-66067)).

### SUMMARY OF THE INVENTION

In order to generally confirm image quality degradation caused by data compression before the compressed data compressed by the data compressor is actually recorded on a recording medium, such a scheme is performed in which an compressed image once compressed is decompressed and displayed, and an operator sees the displayed image to confirm the state of image quality.

In the case in which the resolution of the compressed image is SD (Standard Definition), for example, an operator can easily find a degraded portion in image quality from the displayed image, but in the case in which the compressed image is a high definition image of HD (High Definition) and above, it is difficult to find a degraded portion in image quality from the displayed image, and some experiences are necessary to do so.

In other words, in the manner before, in the case in which a compressed image is a high definition image, it is difficult for an operator to easily find a degraded portion in image quality.

Thus, it is desirable to display an image corresponding to a compressed image so as to emphasize a degraded portion in image quality of the compressed image.

A display control apparatus according to an embodiment of the invention is a display control apparatus including: an input means for inputting an image of a compression target; a comparing means for comparing an input image inputted from the input means with a decompressed image that is obtained by decompressing a compressed image obtained by compressing the input image; an image processing means for changing a pixel value of a predetermined pixel of the decompressed image to a predetermined value based on a compared result by the comparing means; and a display means for displaying the decompressed image in which a pixel value is changed by the image processing means.

The comparing means may compute an amount of difference of a pixel value between pixels corresponding to the input image and the decompressed image, and the image processing means may replace a pixel value of a pixel of the decompressed image in which the amount of difference exceeds a predetermined reference value with a predetermined substitute value.

The comparing means may compute an amount of difference of a brightness value or a color difference value between pixels corresponding to the input image and the decompressed image, or amounts of difference of both of a brightness value and a color difference value, and the image processing means may replace a brightness value or a color difference value of a pixel of the decompressed image in which the amount of difference exceeds a predetermined reference value, or both of a brightness value and a color difference value with a predetermined substitute value.

A display control method, or a program according to an embodiment of the invention is a display control method, or a program including the steps of: inputting an image of a compression target; comparing an input image inputted in the inputting step with a decompressed image that is obtained by decompressing a compressed image obtained by compressing the input image; changing a pixel value of a predetermined pixel of the decompressed image to a predetermined value based on a compared result in the comparing step; and displaying the decompressed image in which a pixel value is changed in the image processing step.

In the display control apparatus, the display control method, or the program according to an embodiment of the invention, the image of the compression target is inputted, the input image inputted is compared with the decompressed image that is obtained by decompressing the compressed image obtained by compressing the input image, the pixel value of a predetermined pixel of the decompressed image is changed to a predetermined value based on a compared result, and the decompressed image in which a pixel value is changed is displayed.

It is desirable to display an image corresponding to a compressed image so as to emphasize a degraded portion in image quality of the compressed image, for example.

### BRIEF DESCRIPTION OF THE DRAWINGS

FIG. 1 shows a block diagram depicting an exemplary configuration of a data compressor to which an embodiment of the invention is adapted;

FIG. 2 shows a flow chart illustrative of the operation of an image processing circuit shown in FIG. 1;

FIGS. 3A to 3C show a diagram depicting exemplary image processing;

FIGS. 4A to 4C show a diagram depicting another exemplary image processing;

FIGS. 5A to 5B show a diagram depicting still another exemplary image processing;

FIGS. 6A to 6C show a diagram depicting yet another exemplary image processing;

FIGS. 7A to 7C show a diagram depicting still yet another exemplary image processing;

FIGS. 8A to 8C show a diagram depicting still another exemplary image processing;

FIGS. 9A to 9C show a diagram depicting yet another exemplary image processing;

FIGS. 10A to 10C show a diagram depicting still yet another exemplary image processing;

FIGS. 11A to 11C show a diagram depicting still another exemplary image processing;

FIG. 12 shows a diagram depicting yet another exemplary image processing;

FIG. 13 shows a diagram depicting still yet another exemplary image processing; and

FIG. 14 shows a block diagram depicting an exemplary configuration of a computer to which an embodiment of the invention is adapted.

### DETAILED DESCRIPTION OF THE INVENTION

Hereinafter, an embodiment of according to an embodiment of the invention will be described. The following is examples of the correspondence between configuration requirements for according to an embodiment of the invention and the embodiments of the specification or the drawings. This is described for confirming that the embodiments supporting according to an embodiment of the invention are described in the specification or the drawings. Therefore, even though there is an embodiment that is described in the specification or the drawings but is not described herein as an embodiment corresponding to configuration requirements for the invention, it does not mean that the embodiment does not correspond to those configuration requirements. Contrary to this, even though an embodiment is described herein as an embodiment corresponding to configuration requirements, it does not mean that the embodiment does not correspond to configuration requirements other than those configuration requirements.

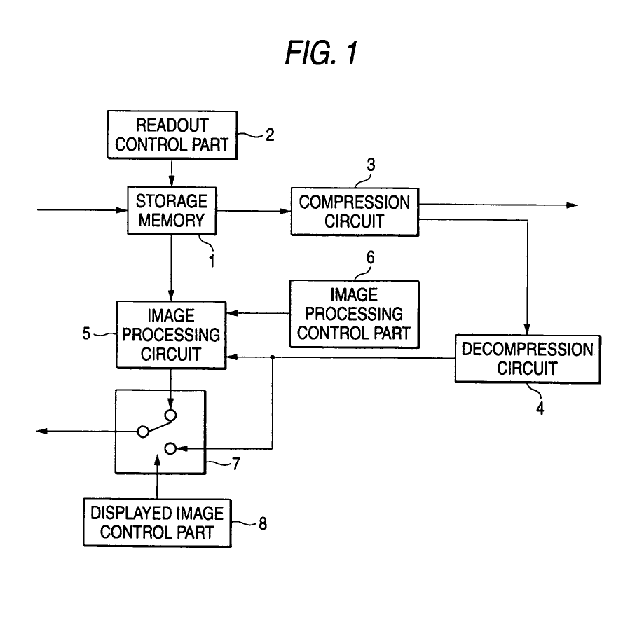

A display control apparatus according to an embodiment of the invention is a display control apparatus including: an input means (for example, a storage memory 1 in FIG. 1) for inputting an image of a compression target; a comparing means (for example, an image processing circuit 5 shown in FIG. 1) for comparing an input image inputted from the input means with a decompressed image that is obtained by decompressing a compressed image obtained by compressing the input image; an image processing means (for example, an image processing circuit 5 shown in FIG. 1) for changing a pixel value of a predetermined pixel of the decompressed image to a predetermined value based on a compared result by the comparing means; and a display means (for example, a displayed image control part 8 in FIG. 1) for displaying the decompressed image in which a pixel value is changed by the image processing means.

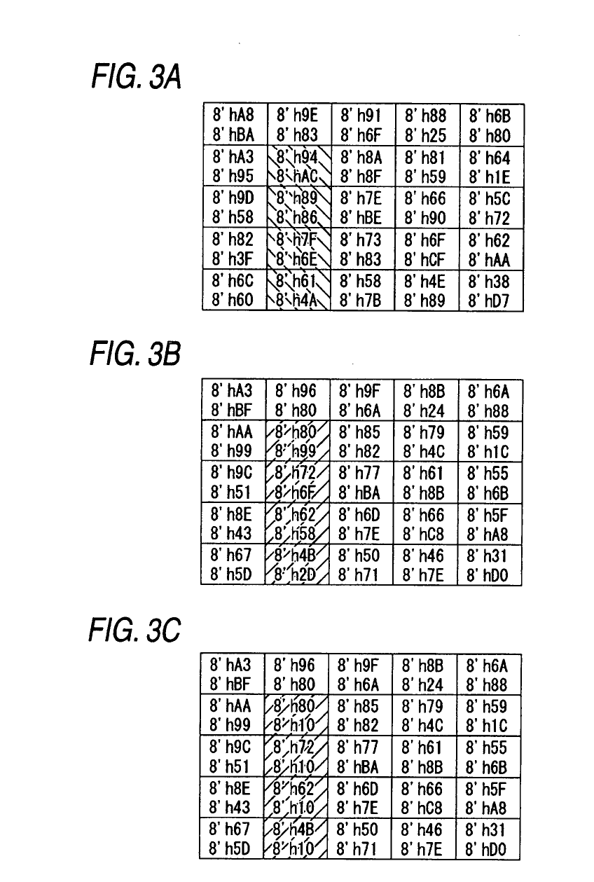

The comparing means may compute an amount of difference of a pixel value between pixels corresponding to the input image and the decompressed image (for example, FIGS. 3A and 3B), and the image processing means may replace a pixel value of a pixel of the decompressed image in which the amount of difference exceeds a predetermined reference value with a predetermined substitute value (for example, FIG. 3C).

The comparing means may compute an amount of difference of a brightness value or a color difference value between pixels corresponding to the input image and the decompressed image, or amounts of difference of both of a brightness value and a color difference value (for example, FIGS. 3A and 3B), and the image processing means may replace a brightness value or a color difference value of a pixel of the decompressed image in which the amount of difference exceeds a predetermined reference value, or both of a brightness value and a color difference value with a predetermined substitute value (for example, FIG. 3C).

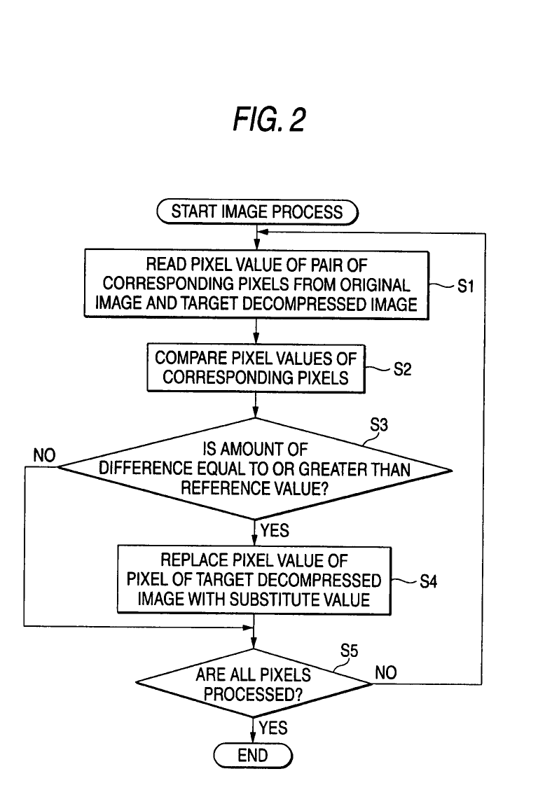

A display control method, or a program according to an embodiment of the invention is a display control method, or a program including the steps of: inputting an image of a compression target (for example, the process of a storage memory 1 in FIG. 1); comparing an input image inputted in the inputting step with a decompressed image that is obtained by decompressing a compressed image obtained by compressing the input image (for example, in Step S2 in FIG. 2); changing a pixel value of a predetermined pixel of the decompressed image to a predetermined value based on a compared result in the comparing step (for example, in Step S3 and Step S4 in FIG. 2); and displaying the decompressed image in which a pixel value is changed in the image processing step (for example, the process of a displayed image control part 8 in FIG. 1).

FIG. 1 shows an exemplary configuration of a data compressor to which an embodiment of the invention is adapted.

A storage memory 1 receives an input image to be a compression target supplied to the data compressor, and the storage memory 1 temporarily stores the entered input image in units of frames, for example.

The storage memory 1 reads the stored input image in units of frames, for example, under control done by the readout control part 2, and supplies it to a compression circuit 3 or an image processing circuit 5.

The compression circuit 3 compresses the input image read out of the storage memory 1 in compliance with the MPEG (Moving Picture Expert Group) standards, for example, and externally outputs the compressed image thus obtained, or supplies it to a decompression circuit 4.

The decompression circuit 4 decompresses the compressed image supplied from the compression circuit 3 in compliance with the standards MPEG, for example, and supplies the decompressed image thus obtained to the image processing circuit 5 and a switch 7.

The storage memory 1 reads the input image (hereinafter, referred to as an original image) that is the original of the decompressed image out of the decompression circuit 4, and the image is inputted to the image processing circuit 5.

For example, in the case in which ten frames of the input image are inputted to the storage memory 1 during the period for which a single frame of the input image read out of the storage memory 1 is supplied to the compression circuit 3, the image is compressed there and supplied to the decompression circuit 4, and the image is decompressed there and inputted to the image processing circuit 5, the readout control part 2 allows the storage memory 1 to delay reading the input image to the image processing circuit 5 by ten frames of input time. As described above, the readout of the storage memory 1 to the image processing circuit 5 is controlled, whereby the image processing circuit 5 receives the original image and the decompressed image obtained from the original image (hereinafter, referred to as a target decompressed image).

The image processing circuit 5 compares the original image read and inputted from the storage memory 1 with the target decompressed image from the decompression circuit 4 under control done by an image processing control part 6, and applies a predetermined process to the target decompressed image in accordance with the compared result.

For example, the image processing circuit 5 takes the amount of difference of the pixel value between the original image and the target decompressed image for every corresponding pixel, and replaces the pixel value of the pixels of the target decompressed image that have the amount of difference exceeding a predetermined reference value with a predetermined substitute value. The detail of this process will be described later.

The image processing circuit 5 supplies the target decompressed image subjected to a predetermined process to the image display shifting switch 7.

The image display shifting switch 7 selects the decompressed image to which a predetermined process is applied and which is supplied from the image processing circuit 5, or selects the decompressed image supplied from the decompression circuit 4 in accordance with the instruction from a displayed image control part 8, and outputs it to display device, not shown, for display.

Next, the operation of the image processing circuit 5 will be described with reference to a flow chart shown in FIG. 2.

In Step S1, the image processing circuit 5 reads the pixel value of a pair of the corresponding pixels from the original image and the target decompressed image.

In Step S2, the image processing circuit 5 computes the amount of difference of the pixel value between the pixel of the original image read in Step S1 and the pixel of the target decompressed image, and in Step S3, it determines whether the amount of difference is equal to or greater than a predetermined reference value.

If the image processing circuit 5 determines that the amount of difference is equal to or greater than the reference value in Step S3, it goes to Step S4, replaces the pixel value of the pixel of the target decompressed image read in Step S1 with a predetermined substitute value, and goes to Step S5.

If it is determined that the amount of difference is smaller than the reference value in Step S3, the process in Step S4 is skipped, that is, the pixel value of the pixel of the target decompressed image is not replaced with the substitute value, and the process goes to Step S5.

In Step S5, the image processing circuit 5 determines whether all the pixels of the original image and the target decompressed image are subjected to the process steps in Step S1 to Step S4. If it determines that unprocessed pixels remain, returns to Step S1, and reads the pixel value of the subsequent pixel to similarly perform the process steps after Step S2.

If it is determined that all the pixels have been processed in Step S5, the process is ended.

The process steps in Step S1 to Step S5 are repeatedly performed for each frame of the input image and the decompressed image.

As described above, in comparison with the original image, since it can be considered that the pixel of the target decompressed image having a certain amount of difference is degraded in the image quality, the pixel value of such a pixel is replaced with a predetermined substitute value, whereby the decompressed image can be displayed so that the portion of such pixels is emphasized (that is, visually emphasized) in contrast with the portion of the other pixels (the portion in which the image quality is not degraded). Consequently, an operator can easily find the portion in which the image quality is degraded from the displayed image corresponding to the decompressed image.

Next, image processing in the image processing circuit 5 described above will be described based on a specific example.

For example, the color difference values of the individual pixels of the original image and the target decompressed image are compared with each other, and the color difference value of the pixel of the target decompressed image having the amount of difference exceeding a predetermined reference value (for example, 8′h0F) can be replaced with a predetermined substitute value (for example, 8′h10).

In this example, for example, in the case in which an original image including the pixels having the pixel values shown in FIG. 3A and a target decompressed image including the pixels that correspond to the pixels shown in the original image in FIG. 3A and have the pixel values shown in FIG. 3B are supplied to the image processing circuit 5, the amount of difference of the color difference value between the hatched pixels of the original image in FIG. 3A and the hatched pixels of the target decompressed image in FIG. 3B is equal to or greater than 8′h0F that is the reference value. Therefore, the color difference value of the hatched pixels of the target decompressed image in FIG. 3B is replaced with 8′h10 that is the substitute value as shown in FIG. 3C.

As described above, the color difference value of the pixel in which the image quality is degraded is replaced with a predetermined substitute value. Thus, since the portion is displayed with a certain color, the pixel with the portion is displayed as it is emphasized in contrast with the other pixels.

In addition, each of the grids shown in FIGS. 3A to 3C corresponds to a single pixel, alphanumeric characters “8′hxx” indicated in each grid means that eight bits of a hexadecimal are “xx”, in which eight bits of a hexadecimal in the upper part express a brightness value, and eight bits of a hexadecimal in the lower part express a color difference value. The same thing is applied to the other drawings.

As described above, in comparison with the original image, the pixel value of the pixel of the target decompressed image that obtains the amount of difference equal to or greater than a certain amount is replaced with the pixel value that has a greater amount of difference, for example, whereby the portion of the pixel in which a difference equal to or greater than a certain amount is generated in comparison with the original image can be visually emphasized and displayed when the decompressed image is displayed (that is, the portion in which the image quality is degraded).

In addition, the brightness values of the individual pixels of the target decompressed image and the original image are compared, and the brightness value of the pixel of the target decompressed image in which the amount of difference exceeding a predetermined reference value (for example, 8′h0F) is obtained can be replaced with a predetermined substitute value (for example, 8′h10).

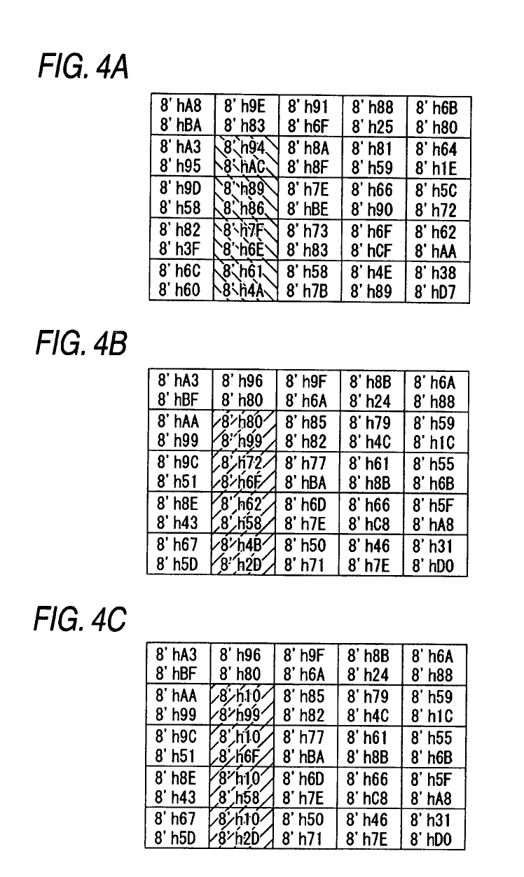

In this example, for example, in the case in which an original image including the pixels having the pixel values shown in FIG. 4A and a target decompressed image including the pixels that correspond to the pixels shown in the original image in FIG. 4A and have the pixel values shown in FIG. 4B are supplied to the image processing circuit 5, the amount of difference of the brightness value between the hatched pixels of the original image in FIG. 4A and the hatched pixels of the target decompressed image in FIG. 4B is equal to or greater than 8′h0F that is the reference value. Therefore, the brightness value of the hatched pixels of the target decompressed image in FIG. 4B is replaced with 8′h10 that is the substitute value as shown in FIG. 4C.

As described above, the brightness value of the pixel in which the image quality is degraded is replaced with a predetermined substitute value. Thus, since the portion is displayed with certain brightness, the portion of the pixel is emphasized and displayed in contrast with the other pixels.

In addition, both of the brightness value and the color difference value of the individual pixels of the original image and the target decompressed image are compared, the brightness value of the pixel of the target decompressed image in which the amounts of difference of the brightness value and the color difference value exceed a predetermined reference value (for example, both values exceed 8′h0F) can be replaced with a predetermined substitute value (for example, 8′h10), and the color difference value of the pixel can be replaced with a predetermined substitute value (for example, 8′hFO).

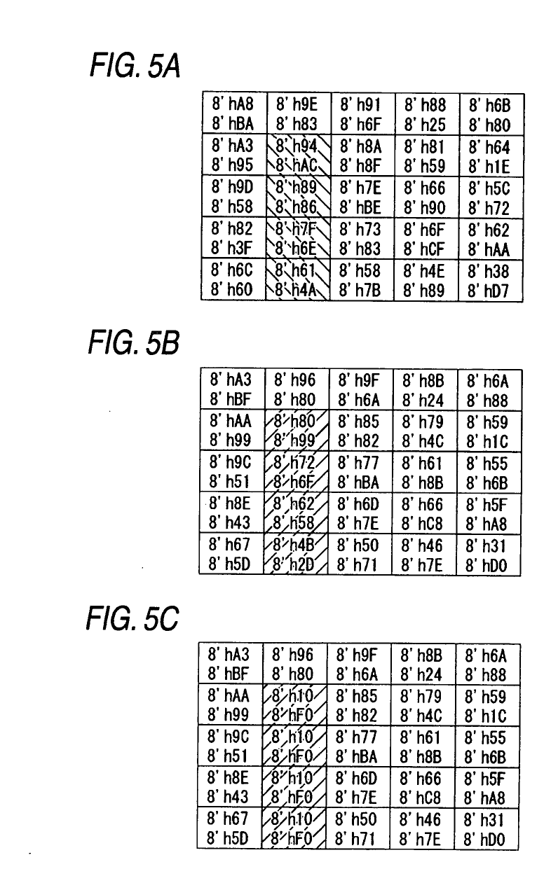

In this example, for example, in the case in which an original image including the pixels having the pixel values shown in FIG. 5A and a target decompressed image including the pixels that correspond to the pixels of the original image in FIG. 5A and have the pixel values shown in FIG. 5B are supplied to the image processing circuit 5, the amounts of difference of the brightness value and the color difference value between the hatched pixels of the original image in FIG. 5A and the hatched pixels of the target decompressed image in FIG. 5B are equal to or greater than 8′h0F that is the reference value. Therefore, the brightness value and the color difference value of the hatched pixels of the target decompressed image in FIG. 5B are replaced with 8′h10 and 8′hFO, respectively, as shown in FIG. 5C.

As described above, since both of the color difference value and the brightness value are compared, the pixel in which the image quality is degraded can be detected more accurately. In addition to this, since the color difference value and the brightness value of the pixel are replaced with a predetermined substitute value, the portion is displayed with a certain color and certain brightness, the pixel is emphasized and displayed in contrast with the other pixels.

In addition, the brightness values of the individual pixels of the original image and the target decompressed image are compared, the color difference value of the pixel of the target decompressed image that obtains the amount of difference of the brightness value exceeding a predetermined reference value (for example, 8′h0F) can be replaced with a predetermined substitute value (for example, 8′hF0).

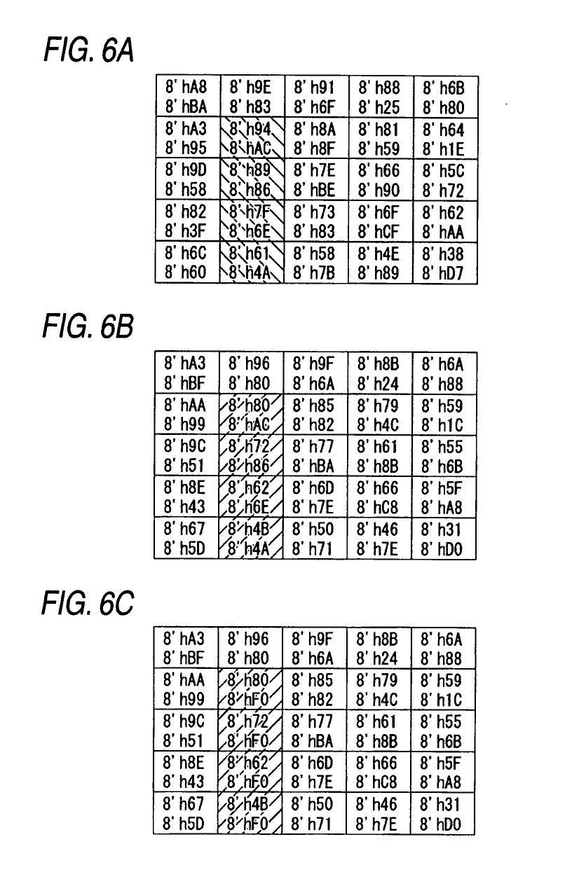

In this example, for example, in the case in which an original image including the pixels having the pixel values shown in FIG. 6A and a target decompressed image including the pixels that correspond to the pixels shown in the original image in FIG. 6A and have the pixel values shown in FIG. 6B are supplied to the image processing circuit 5, the amount of difference of the brightness value between the hatched pixels of the original image in FIG. 6A and the hatched pixels of the target decompressed image in FIG. 6B is equal to or greater than 8′h0F that is the reference value. Therefore, the color difference value of the hatched pixels of the target decompressed image in FIG. 6B is replaced with 8′hF0 that is the substitute value as shown in FIG. 6C.

In this example, the brightness values are compared, and the color difference value is changed based on the compared result.

Moreover, both of the brightness value and the color difference value between the individual pixels of the original image and the target decompressed image are compared, and the brightness value and the color difference value of the pixel of the target decompressed image that the amounts of difference of the brightness value and the color difference value exceed a predetermined reference value (for example, both exceed 8′h0F) can be replaced with the value that is determined from the pixel value of the pixel in the relation of a predetermined position to the pixel on the original image that corresponds to the pixel in which the pixel value of the target decompressed image is replaced.

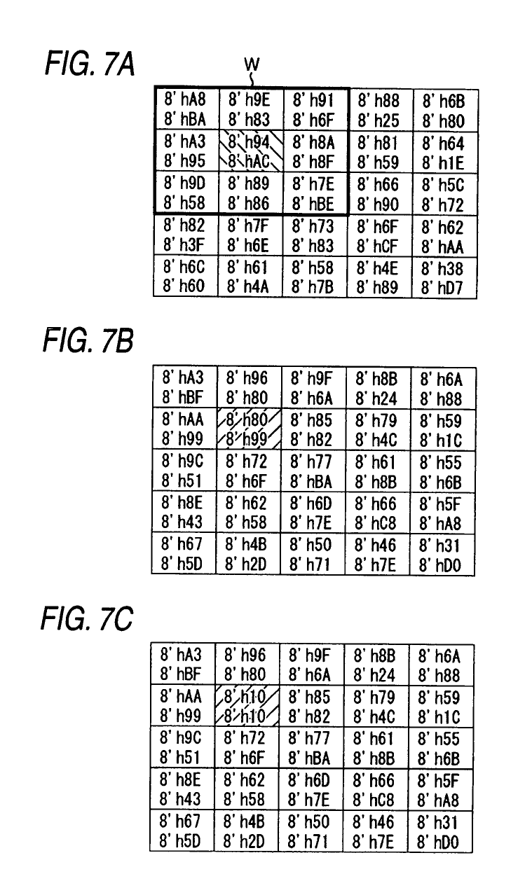

In this example, for example, in the case in which an original image including the pixels having the pixel values shown in FIG. 7A and a target decompressed image including the pixels that correspond to the pixels shown in the original image in FIG. 7A and have the pixel values shown in FIG. 7B are supplied to the image processing circuit 5, the amounts of difference of the brightness value and the color difference value between the hatched pixels of the original image in FIG. 7A and the hatched pixels of the target decompressed image in FIG. 7B are equal to or greater than 8′h0F that is the reference value. Therefore, the brightness value and the color difference value of the hatched pixels of the target decompressed image in FIG. 7B are replaced with 8′h10 and 8′h10 that are relatively opposite values with respect to the average values of the brightness value and the color difference value of 3×3 pixels surrounded by a frame W shown in the original image in FIG. 7A around the pixel that corresponds to the hatched pixel of the target decompressed image in FIG. 7B (for example, the average value of the brightness values=8′h94 (=8′hA8+8′h9E+8′h91+8′hA3+8′h94+8′h8A+8′h9D+8′h89+8′h7E)÷9).

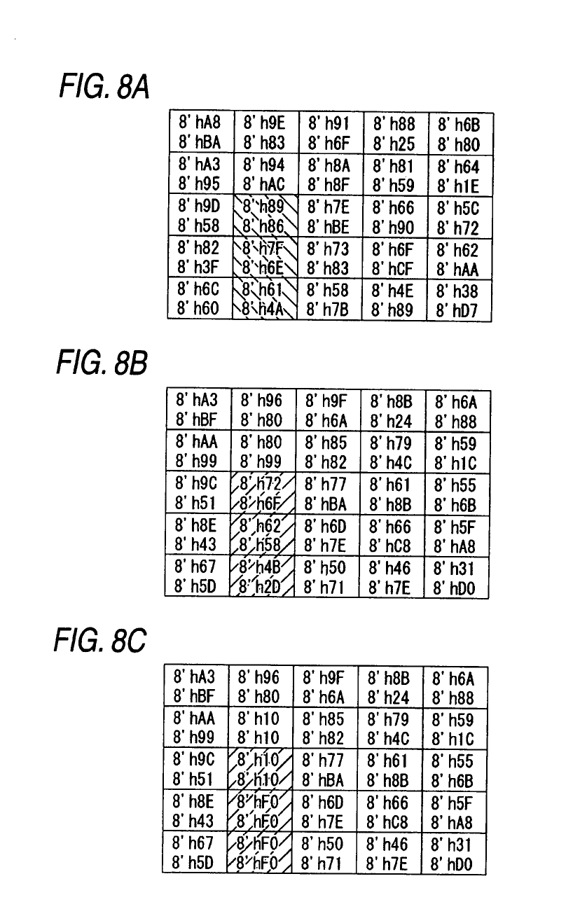

Furthermore, in the examples shown in FIGS. 7A and 7B, the amounts of difference of the brightness value and the color difference value between the hatched pixels of the original image in FIG. 8A and the hatched pixels of the target decompressed image in FIG. 8B are equal to or greater than 8′h0F. Therefore, the scheme as described above is performed, and then the pixel value of the hatched pixels of the target decompressed image in FIG. 8B is replaced with a relatively opposite value with respect to the average values of the brightness value and the color difference value of 3×3 pixels that correspond to the hatched pixels of the target decompressed image in FIG. 8B around the corresponding pixels of the original image in FIG. 8A, as shown in FIG. 8C.

As described above, the pixel value of the pixel in which the image quality is degraded is based on the pixel value of the pixels of the original image in a predetermined range corresponding thereto. Therefore, the pixel can be displayed putting more emphasis thereon in contrast with the pixel in which the image quality is not degraded.

In the case in which both of the brightness value and the color difference value of the individual pixels of the original image and the target decompressed image are compared and there are a predetermined number or greater of pixels that obtain the amounts of difference of the brightness value and the color difference value exceeding a predetermined reference value (for example, 8′h0F) for the pixels of the target decompressed image in every predetermined range, the pixel value of the pixels of the target decompressed image in that range can be replaced with a predetermined value.

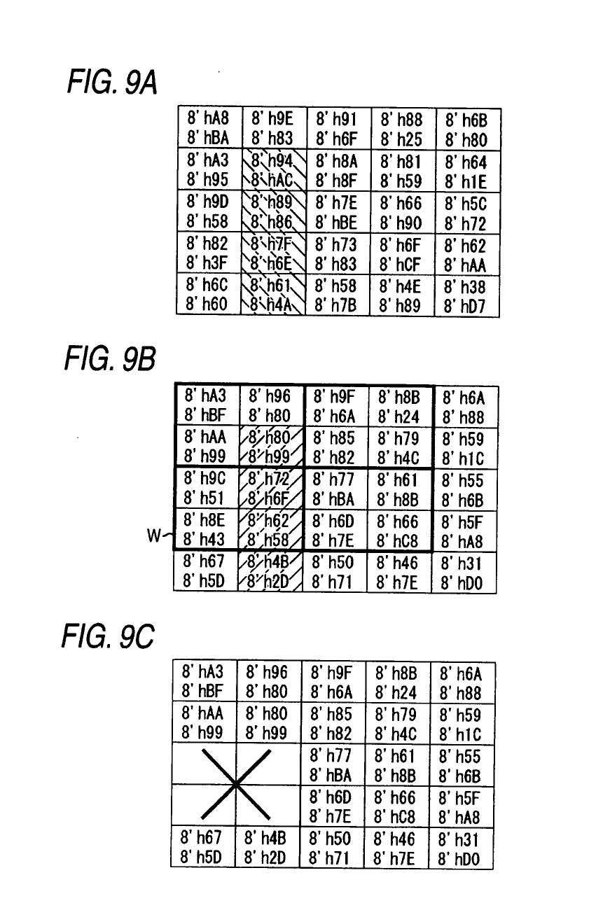

In this example, for example, in the case in which an original image including the pixels having the pixel values shown in FIG. 9A and a target decompressed image including the pixels that correspond to the pixels of the original image in FIG. 9A and have the pixel values shown in FIG. 9B are supplied to the image processing circuit 5 and there are two or more pixels exceeding the reference value in 2×2 pixels indicated by a thick line in FIG. 9B, the pixel value of the pixels in that range is replaced with a pattern “X” displayed in the image area corresponding to the range.

In this case, the amounts of difference of the brightness value and the color difference value of the hatched pixels between the original image in FIG. 9A and the hatched pixels of the target decompressed image in FIG. 9B are equal to or greater than 8′h0F that is the reference value, and there are two pixels that obtain the amount of difference exceeding the reference value in the area W shown in FIG. 9B. Therefore, the pixel value of the pixels in the area W is replaced with the pixel value in which the pattern “X” is displayed in the image area corresponding to the area W as shown in FIG. 9C.

In addition, both of the brightness value and the color difference value between the individual pixels of the original image and the target decompressed image are compared, and the pixel value of the pixels other than the pixels that the amounts of difference of the brightness value and the color difference value of the target decompressed image exceed a predetermined reference value (for example, both are 8′h0F) can be replaced with a predetermined pixel value.

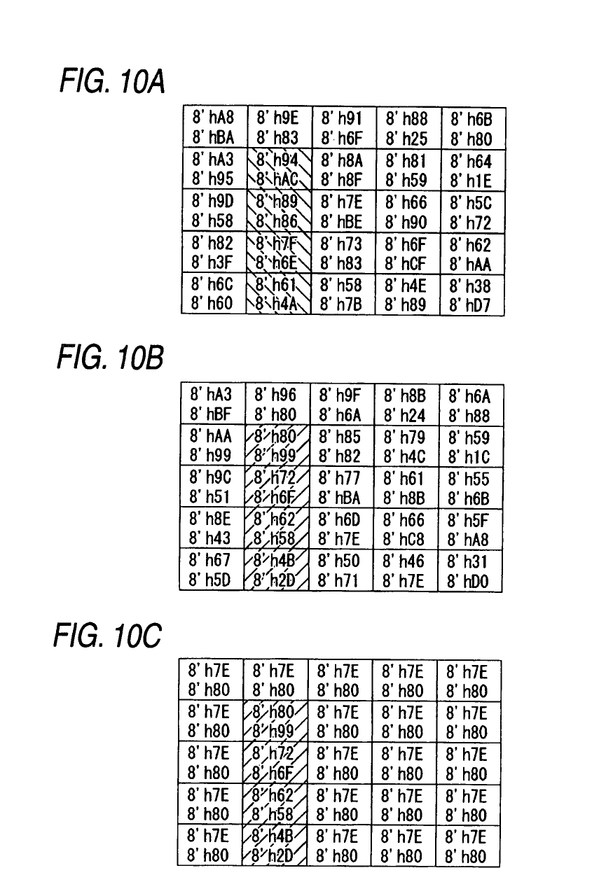

In this example, for example, in the case in which an original image including the pixels having the pixel values shown in FIG. 10A and a target decompressed image including the pixels that correspond to the pixels of the original image in FIG. 10A and have the pixel values shown in FIG. 10B are supplied to the image processing circuit 5, the amounts of difference of the brightness value and the color difference value between the hatched pixels of the original image in FIG. 10A and the hatched pixels of the target decompressed image in FIG. 10B are equal to or greater than 8′h0F that is the reference value. Therefore, the brightness value and the color difference value of the pixels other than the hatched pixels of the target decompressed image in FIG. 10B are replaced with 8′h7E and 8′h80 that are the substitute value as shown in FIG. 10C. Consequently, the portions of the pixels other than the hatched pixels of the target decompressed image in FIG. 10C are displayed in gray.

In addition, the brightness values of the individual pixels of the original image and the target decompressed image are compared, and the pixel value of the pixels of the target decompressed image can be replaced so that the pixels of the target decompressed image are displayed in color that corresponds to the amount of difference.

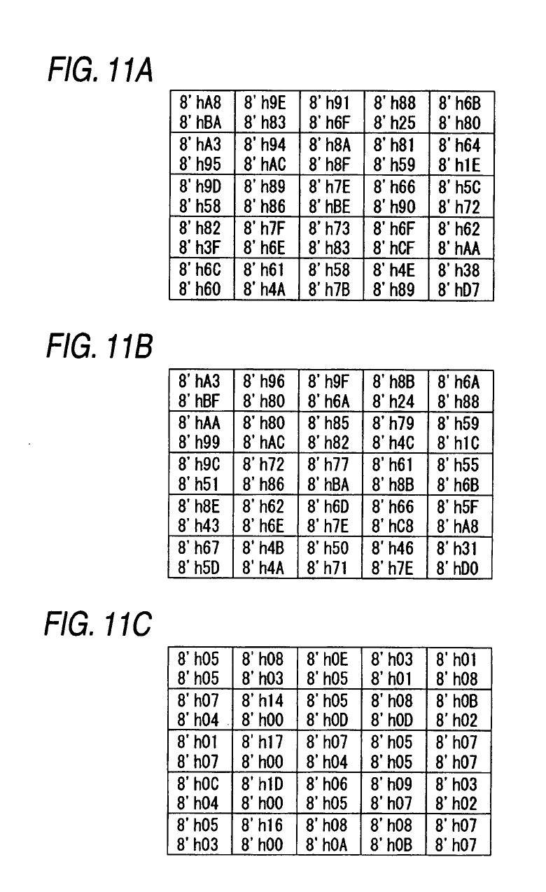

In this example, for example, in the case in which an original image including the pixels having the pixel values shown in FIG. 11A and a target decompressed image including the pixels that correspond to the pixels of the original image in FIG. 11A and have the pixel values shown in FIG. 11B are supplied, the pixels of the target decompressed image are replaced to have the pixel value so that the pixels are displayed in color corresponding to the amount of difference of the brightness value of the pixels as shown in FIG. 11C.

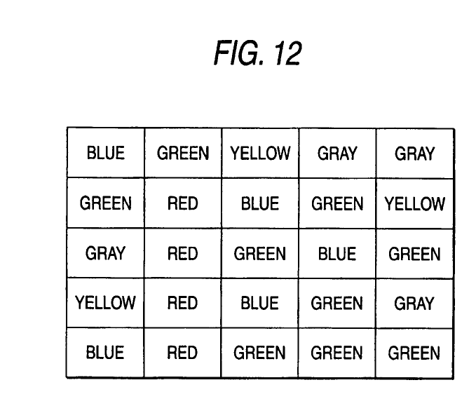

In other words, the pixels having the pixel values shown in FIG. 11C are displayed in colors denoted on grids shown in FIG. 12.

In addition, the examples shown in FIGS. 3A to 12 described above are only examples, and for example, such a scheme may be adapted that displays an arrow indicating the portion in which the image quality is degraded as long as the portion in which the image quality is degraded is subjectively, easily recognized by the scheme.

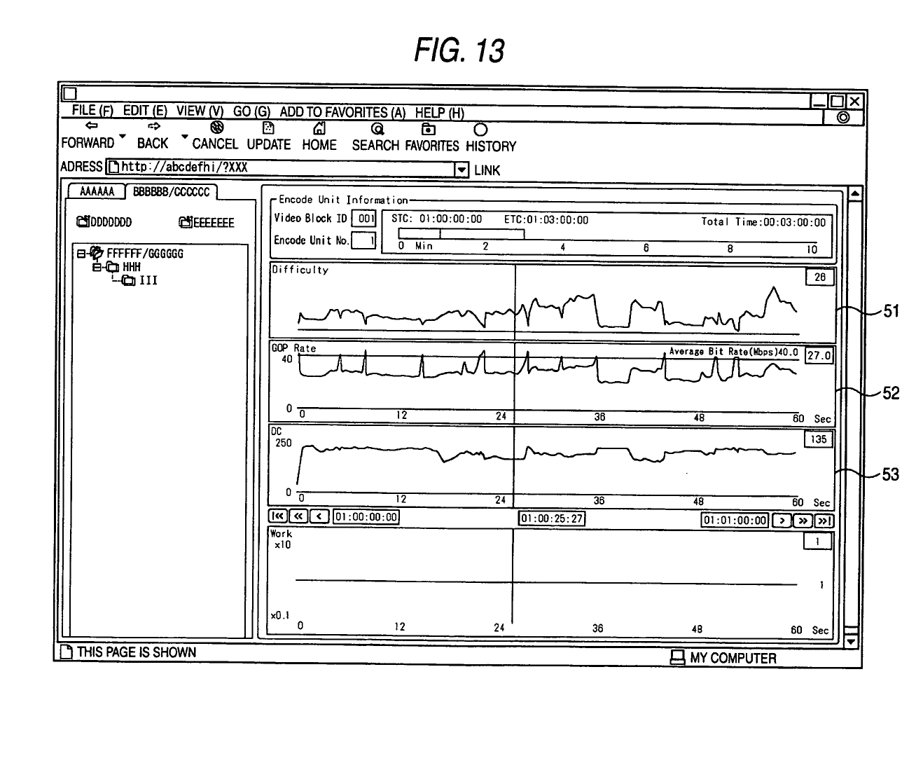

Moreover, in the examples shown in FIGS. 3A to 12 described above, the decompressed image is processed so that the portion in which the image quality is degraded is emphasized and displayed. For example, in the case in which encode processing is performed in accordance with 2 pass encoding, as shown in FIG. 13, a predetermined screen can be displayed on which an input image and a decompressed image are displayed on a display part 53 as corresponding to the degree of difficulty in coding obtained at the time of display on a display part 51 and to the GOP bit rate displayed on a display part 52. Since it is known that the tendency of degrading the image quality is associated with the degree of difficulty and the GOP rate, the amount of difference is associated with the degree of difficulty and the GOP rate for display as described above, whereby an operator can easily know which portion is a degraded portion in image quality.

In addition, 2 pass encoding is a scheme in which an input material is temporarily encoded in a fixed quantizing step in compliance with the MPEG standards, for example, the coded amount generated at this time is acquired as the degree of difficulty in coding, a target data volume generated at actual encoding is decided based on the degree of difficulty, and actual encoding is performed at the quantizing step in which the target data volume is generated.

In addition, as described above, the descriptions of control in the displayed image control part 8 are not shown specifically, but for example, the displayed image can be controlled so that the input image can be visually compared with the decompressed image in which the pixel value of the pixel is replaced with a predetermined substitute value in accordance with the amount of difference of the pixel value of the pixels corresponding to the input image and the decompressed image.

For example, in the case in which an input image and a decompressed image are arranged side by side and displayed on a display device, on the display part on which the decompressed image is displayed, images are displayed such a way that the decompressed image is switched with the decompressed image in which the pixel value of the pixel having the amount of difference exceeded from a predetermined reference value is replaced with a predetermined substitute value. The images are displayed in this manner, whereby the portion can be easily identified in the decompressed image, the portion in which the amount of difference of the pixel value between the pixels corresponding to the input image and the decompressed image exceeds a predetermined reference value, and the portion can actually visually seen and compared.

In addition, in the case in which an input image and a decompressed image are arranged side by side and displayed on a display device, the input image and the decompressed image may be displayed that have the portion in which the amount of difference of the pixel value between the pixels corresponding to the input image and the decompressed image exceeds a predetermined reference value. Moreover, at this time, both images may be enlarged and displayed. The images are displayed in this manner, whereby the portion in which the amount of difference of the pixel value between the pixels corresponding to the input image and the decompressed image exceeds a predetermined reference value can be presented to a person who authors to easily, visually confirm the portion.

Next, a series of the process steps described above may be performed by hardware or may be by software. In the case in which a series of the process steps is performed by software, a program configuring the software is installed in a multipurpose computer.

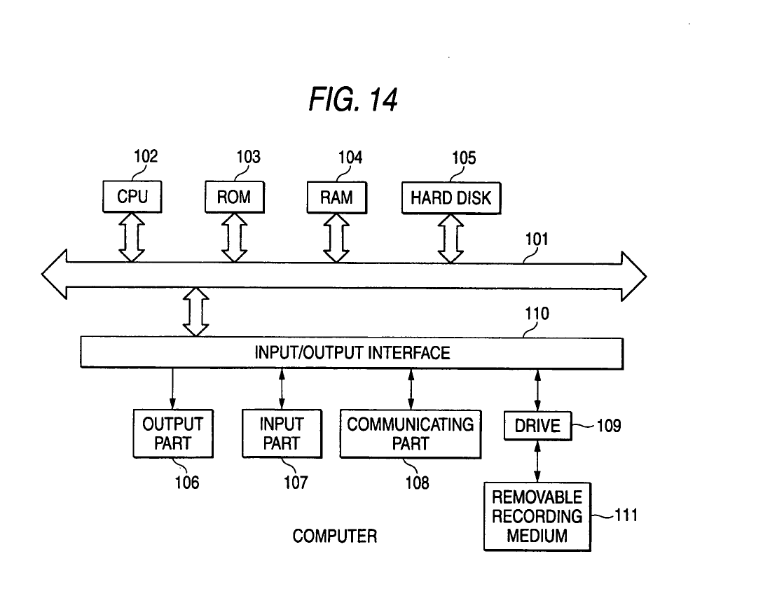

Then, FIG. 14 shows an exemplary configuration of a computer in which a program performing a series of the process steps described above is installed.

The program can be recorded in advance on a hard disk 105 or a ROM 103 as a recording medium incorporated in the computer.

Alternatively, the program can be temporarily or permanently stored (recorded) on a removable recording medium 111 such as a flexible disc, a CD-ROM (Compact Disc Read Only Memory), an MO (Magneto-optical) disc, a DVD (Digital Versatile Disc), a magnetic disc, and a semiconductor memory. The removable recording medium 111 like this can be provided as so-called package software.

Moreover, the program is installed into the computer through the removable recording medium 111 as described above, as well as it can be installed into the hard disk 105 incorporated in the computer from a download site through an artificial satellite for digital satellite broadcast over radio transmission, or installed into the computer through a network such as a LAN (Local Area Network) and the Internet over cable transmission, or installed into the incorporated hard disk 105 by receiving the program thus transmitted by a communicating part 108 in the computer.

The computer has a CPU (Central Processing Unit) 102 therein. To the CPU 102, an I/O interface 110 is connected through a bus 101. When a user manipulates an input part 107 configured of a keyboard, a mouse, a microphone, etc., to enter an instruction to the CPU 102 through the I/O interface 110, it runs the program stored in the ROM (Read Only Memory) 103. Alternatively, the CPU 102 loads into a RAM (Random Access Memory) 104 the program that is stored in the hard disk 105, the program that is transmitted through a satellite or a network, received at the communicating part 108, and installed in the hard disk 105, or the program that is read out of the removable recording medium 111 mounted on a drive 109 and installed into the hard disk 105 for implementation. Thus, the CPU 102 performs the process steps in accordance with the flow charts described above, or runs the process steps performed by the configurations in the block diagrams shown.

Then, the CPU 102 outputs the process results from an output part 106 configured of an LCD (Liquid Crystal Display) and a speaker through the I/O interface 110, etc., as necessary, or transmits the process results from the communicating part 108, or further records the process results on the hard disk 105.

Here, in the specification, the process steps describing the program to allow the computer to run various processes are not necessarily performed in time series along the order described in flow charts, which include the process steps performed in parallel or separately (for example, parallel processing or processing by an object).

In addition, the program may be processed in a single computer, or may be processed by a plurality of computers in distributed processing. Furthermore, the program may be forwarded to a remote computer for implementation.

Moreover, an embodiment of the invention is not limited to the embodiments described above, which can be modified within the scope not deviating from the teaching of an embodiment of the invention.

It should be understood by those skilled in the art that various modifications, combinations, sub-combinations and alterations may occur depending on design requirements and other factors insofar as they are within the scope of the appended claims or the equivalents thereof.

What is claimed is:

1. A display control apparatus comprising:
an input means for inputting an image of a compression target;
a comparing means for comparing an input image inputted from the input means with a decompressed image that is obtained by decompressing a compressed image obtained by compressing the input image;
an image processing means for changing a pixel value of a predetermined pixel of the decompressed image to a predetermined value based on a compared result by the comparing means; and
a display means for displaying the decompressed image in which a pixel value is changed by the image processing means.

2. The display control apparatus according to claim 1, wherein the comparing means computes an amount of difference of a pixel value between pixels corresponding to the input image and the decompressed image, and
the image processing means replaces a pixel value of a pixel of the decompressed image in which the amount of difference exceeds a predetermined reference value with a predetermined substitute value.

3. The display control apparatus according to claim 2, wherein the comparing means computes an amount of difference of a brightness value or a color difference value between pixels corresponding to the input image and the decompressed image, or amounts of difference of both of a brightness value and a color difference value, and
the image processing means replaces a brightness value or a color difference value of a pixel of the decompressed image in which the amount of difference exceeds a predetermined reference value, or both of a brightness value and a color difference value with a predetermined substitute value.

4. A display control method comprising the steps of:
inputting an image of a compression target;
comparing an input image inputted in the inputting step with a decompressed image that is obtained by decompressing a compressed image obtained by compressing the input image;
changing a pixel value of a predetermined pixel of the decompressed image to a predetermined value based on a compared result in the comparing step; and
displaying the decompressed image in which a pixel value is changed in the image processing step.

5. A program which allows a computer to execute a display control process for controlling a display of an image comprising the steps of:
inputting an image of a compression target;
comparing an input image inputted in the inputting step with a decompressed image that is obtained by decompressing a compressed image obtained by compressing the input image;
changing a pixel value of a predetermined pixel of the decompressed image to a predetermined value based on a compared result in the comparing step; and
displaying the decompressed image in which a pixel value is changed in the image processing step.

6. A display control apparatus comprising:
an input unit configured to input an image of a compression target;
a comparing unit configured to compare an input image inputted from the input unit with a decompressed image that is obtained by decompressing a compressed image obtained by compressing the input image;
an image processing unit configured to change a pixel value of a predetermined pixel of the decompressed image to a predetermined value based on a compared result by the comparing unit; and
a display unit configured to display the decompressed image in which a pixel value is changed by the image processing unit.
